(19) United States
(12) Patent Application Publication
(10) Pub. No.: US 2026/0194162 A1
(43) Pub. Date: Jul. 9, 2026

(54) Stand-Off Clamp With Hands-Free Cable Hanger Mounting Plate

(71) Applicant: ConcealFab, Inc., Colorado Springs, CO (US)

(72) Inventor: Flynn McClellan, Colorado Springs, CO (US)

(21) Appl. No.: 19/343,380

(22) Filed: Sep. 29, 2025

Related U.S. Application Data
(63) Continuation-in-part of application No. 29/983,147, filed on Jan. 9, 2025.

(51) Int. Cl. F16L 3/10; H02G 7/20

(52) U.S. Cl. CPC F16L 3/10; H02G 7/20

(57) ABSTRACT

A stand-off clamp includes a hands-free cable hanger mounting plate with a pair of nut positioners configured to support the hands-free cable hanger mounting plate on bracket nuts without the use of hands while the end nuts are installed on the threaded rods to secure the hands-free cable hanger mounting plate between the bracket nuts and the end nuts. The stand-off clamp includes the hands-free cable hanger mounting plate attached to extended threaded rods that also secure the clamp to a support structure. Attaching the mounting plate directly to the extended threaded rods of the clamp allows a wide range of cable hanger configurations to be created with a minimal number of parts.

### REFERENCE TO RELATED APPLICATIONS

This application is a continuation-in-part claiming priority to U.S. Design patent application No. 29983147 filed Jan. 9, 2025, which is incorporated by reference.

### TECHNICAL FIELD

The present invention is directed to cellular communication systems and, more particularly, to a stand-off clamp that includes a hands-free cable hanger mounting plate to facilitate installation.

### BACKGROUND

An essential element of modern mobile communications systems is the “cell site.” The cell site includes one or more cellular base station antennas aimed at a desired geographical area of coverage with coaxial cables connecting the antennas to base station radio equipment. The performance of a cell site is often limited by passive intermodulation (“PIM”) interference. PIM interference occurs when the high-power downlink signals (the “main beam”) transmitted by the base station antenna mixes at passive, non-linear junctions in the RF path, creating new signals. When these new signals (intermodulation products) fall in an antenna's uplink band, they act as interference and reduce the signal-to-interference-plus-noise ratio (“SINR”). As the SINR reduces, the geographic coverage of the cell site reduces and the data capacity of that cell site reduces.

It is well documented that loosely touching metal-to-metal surfaces can behave in a non-linear fashion and become sources of passive intermodulation when illuminated by high power RF signals. Recently, it has been determined that loose metal-to-metal connections located behind base station antennas are also able to generate high levels of passive intermodulation. Even though this region is well outside the main beam of the antenna, enough RF energy is present in this region to excite non-linear objects and generate PIM.

Metal brackets and associated hardware for supporting RF, optical, ground and remote electrical tilt (“RET”) cable are common sources of loose metal-to-metal contact found in the region behind and close to base station antennas. These cables are secured by cable hangers spaced along their length to the antenna support frame to prevent the cables from moving in the wind. Antenna support frames are often constructed using structural steel supports and metal cable hangers are often used to secure the cables to the frame.

Cellular telephone base stations often utilize 6-channel or 12-channel antennas, where each channel has a respective RF cable feeding the antenna. Additional cables may feed the antenna, such as a RET cable, an optical fiber, and so forth. A typical base station antenna may therefore have 6 to 14 cables feeding the antenna. Each of these cables is typically secured to a support structure within 18 inches from the antenna, and then every three feet along the length of the cable. In many cases, the cables loop to other pieces of equipment, such as radios, controllers, and so forth, which may be located in fairly close proximity to the antenna. In a mast-mounted base station, for example, the antennas, radios and controllers are typically mounted to the same mast within a few feet of each other. This requires tight cable routing configurations with demanding cable support requirements.

FIG. 1 (prior art) illustrates a conventional stand-off clamp described in U.S. Pat. No. 11,187,351 (incorporated by reference), which does not include a hands-free cable hanger mounting plate. This leaves the cable hanger mounting plate unsupported while the technician installs the stand-off clamp complicating the installation. A need therefore exists for a more conveniently installed stand-off clamp.

### SUMMARY

The needs described above are met by a stand-off clamp that includes a hands-free cable hanger mounting plate with a pair of nut positioners configured to support the hands-free cable hanger mounting plate on bracket nuts without the use of hands while the end nuts are installed on the threaded rods to secure the hands-free cable hanger mounting plate between the bracket nuts and the end nuts. This facilitates installation of the hands-free cable hanger mounting plate on the threaded rods by a single technician.

The stand-off clamp cable is designed for organizing and securing cables at cellular telephone base station antenna sites. A representative stand-off includes a hands-free cable hanger mounting plate attached to extended threaded rods that also secure the clamp to a support structure. Attaching the hands-free cable hanger mounting plate directly to the extended threaded rods of the clamp allows a wide range of cable hanger configurations to be created with a minimal number of parts. For example, alternative embodiments can be created by varying the stand-off distance between the hands-free cable hanger mounting plate and support structure, the alignment between the hands-free cable hanger mounting plate and the clamp, and the length of the hands-free cable hanger mounting plate. Additional embodiments can be created by attaching two cable hanger mounting place to the same extended threaded rods on opposing sides of the clamp. Hands-free cable hanger mounting plates can be formed from flat plates as well as a variety of channels, such as channels with “C”, “Z”, “U”, and “comb” shaped end profiles.

It will be understood that specific embodiments may include a variety of features in different combinations, as desired by different users. The specific techniques and systems for implementing particular embodiments of the invention and accomplishing the associated advantages will become apparent from the following detailed description of the embodiments and the appended drawings and claims.

### BRIEF DESCRIPTION OF THE FIGURES

The numerous advantages of the embodiments of the invention may be better understood with reference to the accompanying figures.

FIG. 1 (prior art) is a perspective view of a conventional stand-off clamp without a hands-free cable hanger mounting plate.

FIG. 2 a perspective view of an improved stand-off clamp with a hands-free cable hanger mounting plate.

FIG. 3A a top view of the hands-free stand-off clamp.

FIG. 3B a side view of the hands-free stand-off clamp.

FIG. 3C a perspective view of a stand-off clamp supporting the hands-free cable hanger mounting plate.

FIG. 4A a perspective view of the stand-off clamp before the hands-free cable hanger mounting plate is positioned on the receiving nuts.

FIG. 4B a perspective view of the hands-free stand-off clamp after the hands-free cable hanger mounting plate is positioned for hands-free support on the receiving nuts.

FIG. 5 is a front view of a representative hands-free cable hanger supporting plate.

FIG. 6 is a perspective view of a stand-off clamp in a first configuration.

FIG. 7A is a perspective view of a first example cable hanger for use with the stand-off clamp cable mounting system.

FIG. 7B (prior art) is a perspective view of a second example cable hanger for use with the stand-off clamp cable mounting system.

FIG. 7C (prior art) is a perspective view of a third example cable hanger for use with the stand-off clamp cable mounting system.

FIG. 7D (prior art) is a perspective view of a fourth example cable hanger for use with the stand-off clamp cable mounting system.

FIG. 8 is a perspective view of the stand-off clamp in a second configuration.

FIG. 9 is a perspective view of the stand-off clamp in a third configuration.

FIG. 10 is a perspective view of the stand-off clamp in a fourth configuration.

FIG. 11 is a perspective view of the stand-off clamp in a fifth configuration.

FIG. 12 is a perspective view of the stand-off clamp in a sixth configuration.

FIG. 13A is a conceptual top view of a stand-off clamp cable mounting system assembly with a cable hanger mounting channel with a “C” shaped end profile.

FIG. 13B is a conceptual end view of the stand-off clamp with the cable hanger mounting channel with the “C” shaped end profile.

FIG. 14A is a conceptual end view of a cable hanger mounting channel with a “Z” shaped end profile.

FIG. 14B is a conceptual end view of a cable hanger mounting channel with a “U” shaped end profile.

FIG. 14C is a conceptual end view of a cable hanger mounting channel with a “comb” shaped end profile.

FIG. 15A is a conceptual side view of a base station antenna site with a low-PIM stand-off clamp positioned within a potential PIM reactive zone of a base station antenna.

FIG. 15B is a conceptual top view of the base station antenna site with the low-PIM stand-off clamp positioned within the potential PIM reactive zone of a base station antenna.

FIG. 16 is a perspective view of cellular base station equipment including two stand-off clamps.

FIG. 17 is a block diagram illustrating the minimal number of parts of the stand-off clamp cable mounting system.

FIG. 18 is a block diagram illustrating a method for a stand-off clamp cable mounting system.

### DETAILED DESCRIPTION

Embodiments of the invention may be embodied in a stand-off clamp that includes a hands-free cable hanger mounting plate with a pair of nut positioners configured to support the hands-free cable hanger mounting plate on bracket nuts without the use of hands while the end nuts are installed on the threaded rods to secure the hands-free cable hanger mounting plate between the bracket nuts and the end nuts. This facilitates installation of the hands-free cable hanger mounting plate on the threaded rods by a single technician.

The stand-off clamp cable mounting system is designed for organizing and securing cables at cellular telephone base station antenna sites. In an illustrative embodiment, a stand-off clamp includes a hands-free cable hanger mounting plate attached to a pair of extended threaded rods (e.g., clamp bolts) that also secure the clamp to a support structure, such as a mast (e.g., vertical pipe). Attaching the hands-free cable hanger mounting plate directly to the pair of threaded rods provides lateral stability to prevent the hands-free cable hanger mounting plate from rotating with respect to the support structure under the weight of the cables and wind loads. In addition, attaching the hands-free cable hanger mounting plate directly to the threaded rods of the clamp allows a wide range of cable hanger configurations to be created with a minimal number of parts. For example, alternative embodiments can be created by varying the stand-off distance between the hands-free cable hanger mounting plate and support structure, by varying the alignment between the hands-free cable hanger mounting plate and the clamp, and by varying the length of the hands-free cable hanger mounting plate.

Additional alternative embodiments can be created by attaching two mounting plates to the same extended threaded rods on opposing sides of the clamp. Hands-free cable hanger mounting plates can be formed from flat plates as well as a variety of channels, such as channels with “C”, “Z”, “U”, and “comb” shaped end profile shapes. Low passive intermodulation (PIM) embodiments can be created by utilizing low-PIM cable hangers or a low-PIM cable hanger mounting plate, such as a hands-free cable hanger mounting plate fabricated from or coated with a polymeric material.

The design of the stand-off clamp cable mounting system allows a small number of parts to be used to create a wide range of cable hanger configurations. In particular, a supply of clamp brackets, a variety of lengths of threaded rods, a variety of lengths of hands-free cable hanger mounting plates, common assembly hardware (e.g., nuts, washers, lock washers), and a supply of cable hangers can be used to assemble a wide range of cable hanger configurations. Certain stand-off clamps utilize stainless or galvanized steel hands-free cable hanger mounting plates and stainless or galvanized steel assembly hardware. These embodiments exhibit low-PIM performance by firmly tightening the assembly hardware and attaching low-PIM cable hangers to the receptacle holes of the metallic hands-free cable hanger mounting plates. In other assemblies, low-PIM performance by is achieved by utilizing hands-free cable hanger mounting plates fabricated from or coated in a low-PIM polymeric material. These embodiments can utilize cable hangers with metallic feet that attach the cable hangers to the low-PIM hands-free cable hanger mounting plates.

The stand-off clamps improve over conventional cable hanger assemblies because the system can be easily adapted to provide a wide variety of cable support configurations with a minimum number of parts. The stand-off clamp cable mounting system is also designed for organizing and securing a large number of cables to both sides of a support structure, such as a vertical mast, with tight and looping cable routing requirements.

Low-PIM stand-off clamps further improve upon conventional cable hanger assemblies by eliminating the known sources of PIM interference created by cable hanger assemblies in the potential PIM reactive zones near cellular base station antennas. There are three design techniques of the stand-off clamp cable mounting system that help to minimize PIM. Since galvanic steel and stainless steel are on opposite sides of the galvanic spectrum, the first design technique is elimination of galvanic mismatch throughout the assembly by preventing stainless steel components from coming into direct contact with galvanized steel components. In most cases, the clamp that attaches to the support structure is fabricated from galvanized steel because the antenna support structure is usually fabricated from galvanized steel. The threaded rods, hands-free cable hanger mounting plates, and assembly hardware are also typically fabricated from galvanized steel so the entire system is assembled from galvanized steel components. As an alternative, polymeric bushings may be utilized at the connection points between galvanized steel components and stainless steel components to avoid galvanic mismatch. The second design technique is to limit the size of contact surfaces and apply high contact pressure at all metal-to-metal connections by firmly tightening the assembly hardware between the support structure and the clamp, between the clamp and the threaded rods, and between the threaded rods and the hands-free cable hanger mounting plate. A combination of firmly tightening the assembly hardware and limiting the size of the contact surfaces achieves high contact pressure at these interfaces. The third design technique is to insulate the connection between the cable holders and the hands-free cable hanger mounting plate.

Embodiments of the invention may be utilized in concert with other techniques to reduce PIM at cellular base stations, such as the low-PIM cable bracket described in commonly owned U.S. Pat. No. 10,724,655; the low-PIM stackable cable hanger described in commonly owned U.S. Pat. No. 10,637,229; the low-PIM cable hanger spacer described in commonly owned U.S. Patent Pub. No. 20200109800, the low-PIM universal mount described in commonly owned U.S. Patent Pub. No. 20200119425, and the low-PIM cable rail system described in U.S. Pat. No. 10,734,719, which are incorporated by reference. The stand-off clamps may also accept many types conventional metal hangers, such as those described in Paske, U.S. Pat. No. 6,354,543 and Feige, U.S. Pat. No. 8,439,316, which are incorporated by reference. The stand-off clamps may also accept certain conventional plastic cable hangers, such as those described in Vacarro, U.S. Pat. No. 10,253,906, which is also incorporated by reference.

While the low-PIM stand-off clamps can be utilized in any desired location, they are effective for mitigating PIM interference when deployed in the potential PIM reactive zone near a base station antenna. Although PIM generation is a function of the antenna broadcast frequency and power, equipment specifications may use a standard distance, such as 10-feet from the antenna, to establish the potential PIM reactive zone where PIM mitigation is considered to be appropriate. In other cases, the potential PIM reactive zone may be defined relative to the wavelength of the antenna's operational frequency, such as within one or two wavelengths of the downlink (main beam) frequency channel of the antenna.

The cables extending from the base station antenna and associated equipment are typically routed and secured to mounting structures in the potential PIM reactive zone. Even though the cables are typically routed behind the main beam of the antenna, enough RF energy can be present in this region to excite non-linear objects and generate PIM interference. For this reason, all directions from the base station within a standard distance, such as 10-feet from the antenna, may be considered to be within the potential PIM reactive zone. In conventional cell sites, metal cable hangers and associated hardware for supporting RF, optical, ground and remote electrical tilt (“RET”) cables located in the potential PIM reactive zone behind base station antennas are common locations of loose metal-to-metal contact that can generate significant levels of PIM.

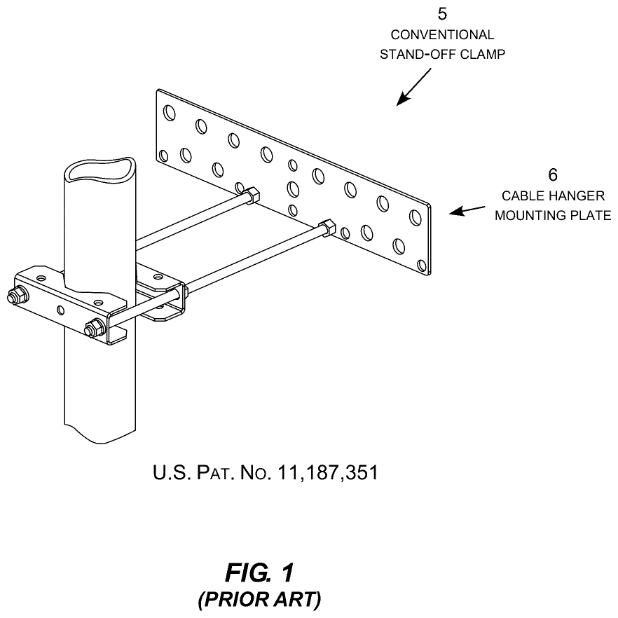

FIG. 1 (prior art) illustrates a conventional stand-off clamp 5 without a hands-free cable hanger mounting plate described in U.S. Pat. No. 11,187,351, which is incorporated by reference. The conventional cable hanger mounting plate 6 receives a variety of cable hangers designed for supporting and organizing cables at a cellular base station antenna. These cable hangers are typically installed on poles or towers which a technician climbs to install the stand-off clamp. Installing the stand-off clamp presents a challenge because the cable hanger mounting plate is loose before tightening the mounting hardware. Since the mounting hardware for each threaded rod includes nuts on the front side and back side of the cable hanger mounting plate, both of the technician's hands are occupied holding wrenches on the mounting hardware. This leaves the mounting plate unsupported, as a third hand or other supporting device would be required to hold both wrenches and the mounting plate at the same time. A need therefore exists for a more conveniently installed stand-off clamp.

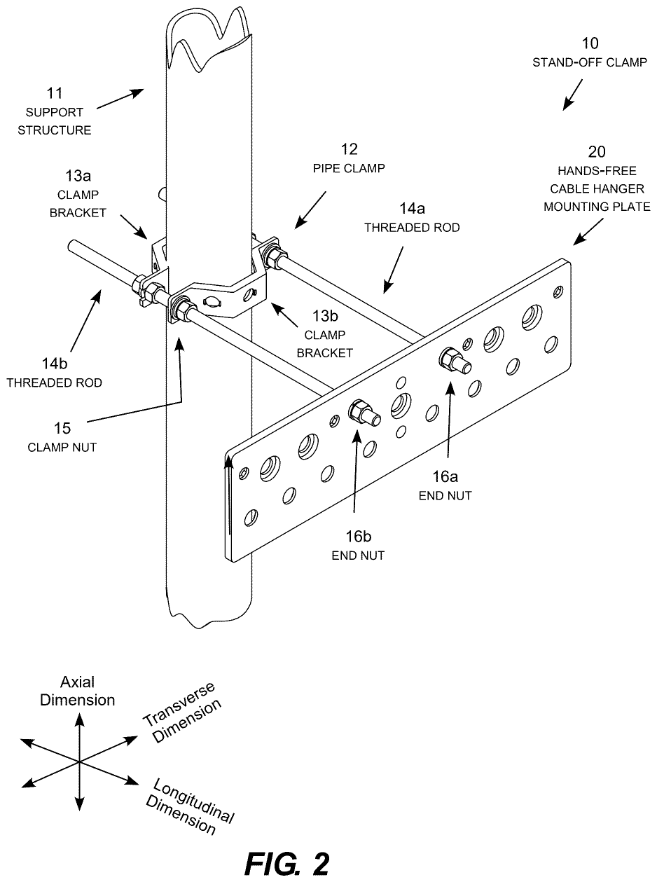

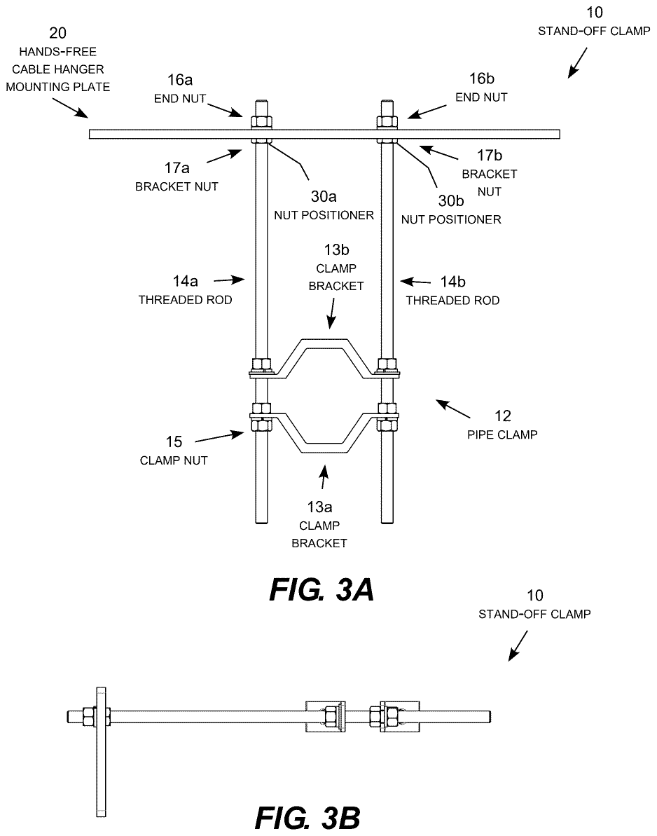

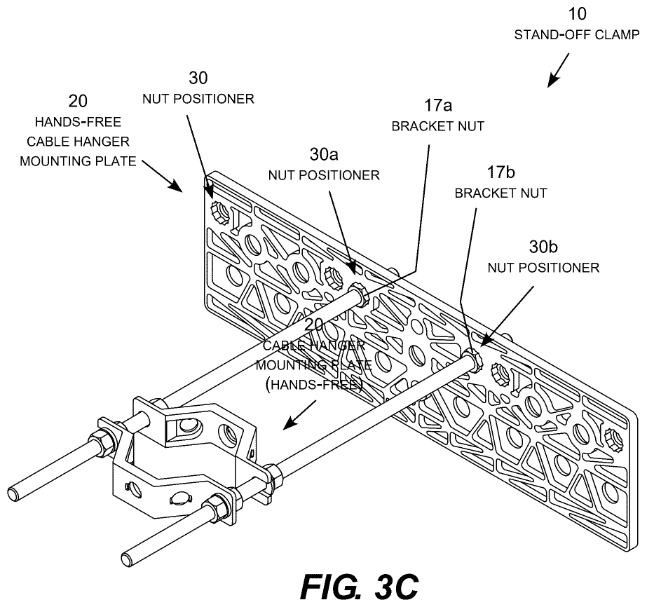

FIG. 2 a perspective view of an improved stand-off clamp 10 with a hands-free cable hanger mounting plate 20 attached to a support structure 11, such as a pole as shown in this example. FIG. 3A is a top view, FIG. 3B a side view, and FIG. 3C a perspective view of the stand-off clamp 10, which includes a pipe clamp 12 for attachment to the support structure 11. The pipe clamp 12 includes clamp brackets 13a and 13b with elongated threaded rods 14a and 14b using clamp nuts represented by the enumerates clamp nut 15 to tighten the pipe clamp 12 on the support structure 11. The elongated threaded rods 14a, 14b extend away from the support structure 11 a selected distance referred to as the stand-off distance for supporting cables. To support a variety of cables, the hands-free cable hanger mounting plate 20 is attached to the distal ends of the threaded rods 14a and 14b, where the plate is captured between end nuts 16a, 16b and respective bracket nuts 17a, 17b. In this stand-off location, the hands-free cable hanger mounting plate 20 supports a variety of cable hangers that, in turn, support a variety of cables.

The improved stand-off clamp 10 simplifies installation of the hands-free cable hanger mounting plate 20 on the threaded rods 14a and 14b by including nut positioners represented by the enumerated nut positioner 30 integrally formed into the hands-free cable hanger mounting plate 20 adjacent to respective threaded rod receptacle holes. The nut positioners are sized and shaped to allow the nut positioners to be pressed by hand snugly onto respective bracket nuts 17a, 17b. In this particular example, two of the nut positioners 30a and 30b are shown installed onto respective nut brackets 17a, 17b. This is typically accomplished by a technician pressing the hands-free cable hanger mounting plate 20 by hand onto the brackets nuts 17a, 17b after the bracket nuts have been threaded onto the threaded rods 14a and 14b the desired stand-off distance. This allows the hands-free cable hanger mounting plate 20 to be held in place hands-free on the bracket nuts 17a, 17b while the end nuts 16a, 16b are installed. The technician then uses free hands to tighten the end nuts 16a, 16b to firmly capture the hands-free cable hanger mounting plate 20 on threaded rods 14a, 14b between the bracket nuts 17a, 17b and respective end nuts 16a, 16b. As the nut positioner prevents the bracket nut from rotating, the technician can install the end nut on the threaded rod with an electric nut driver without having to restrain the corresponding bracket nut with a wrench. This greatly simplifies installation of the hands-free cable hanger mounting plate compared to the conventional cable hanger mounting plate without nut positioners.

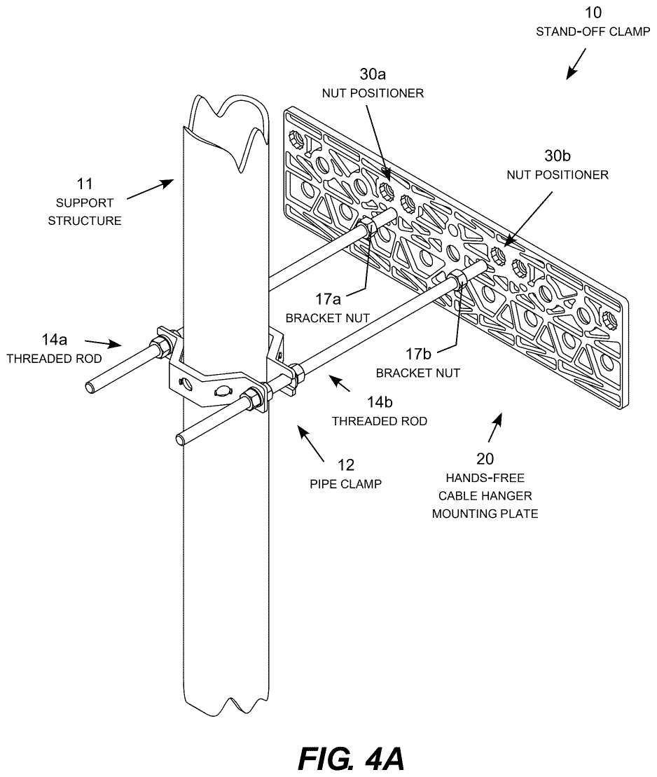

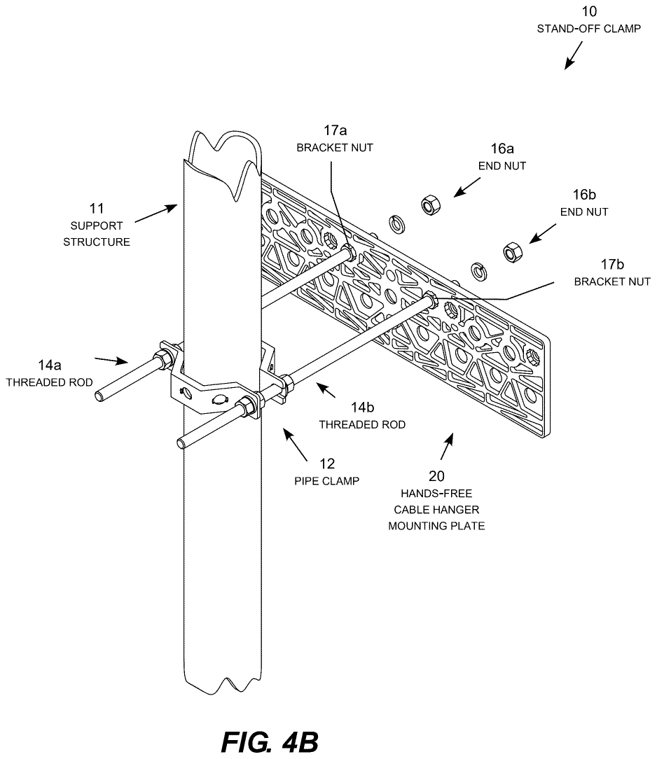

FIGS. 4A and 4B are a perspective view of the stand-off clamp 10 installed on the support structure 11 illustrating a typical installation process facilitated by the hands-free cable hanger mounting plate 20. The installation steps may vary somewhat to achieve the same result, for example by pre-installing the bracket nuts on the threaded rods before attaching the pipe clamp to the support structure. Referring to FIG. 4A, in this example installation procedure, the technician first installs the pipe clamp 12 at the desired position on the support structure 11. The technician then threads the bracket nuts 17a, 17b onto the distal ends of respective threaded rods 14a, 14b the desired stand-off distance from the support structure 11. Referring to FIG. 4B, the technician then maneuvers the hands-free cable hanger mounting plate 20 by hand into position with the nut positioners 30a and 30b on the hands-free cable hanger mounting plate 20 positioned against respective bracket nuts 17a and 17b. The technician may then tweak the rotational position of each bracket nut sufficiently to achieve the alignment required to press-fit the nut positioners 30a, 30b onto respective bracket nuts 17a, 17b. Once the nut positioners 30a, 30b are in place on the bracket nuts 17a, 17b, the hands-free cable hanger mounting plate 20 is snugly held in place hands-free on the threaded rods 14a, 14b at the desired stand-off distance. The technician then has hands free to install and tighten the end nuts 16a, 16b, typically with an electric nut driver on the threaded rods 14a, 14b to firmly capture the hands-free cable hanger mounting plate 20 on the threaded rods between the bracket nuts 17a, 17b and respective end nuts 16a, 16b.

The hands-free cable hanger mounting plate 20 shown in FIGS. 4A-4B includes a number of nut positioners represented by the enumerated nut positioner 30. The specific nut positioners 30a, 30b are called out for the specific alignment of the hands-free cable hanger mounting plate 20 illustrated for the representative example shown. It will be appreciated that the other nut positioners may be used to attach the hands-free cable hanger mounting plate 20 with different longitudinal alignment with respect to the pipe claim 12. Similarly, the other nut positioners may be used to attach the hands-free cable hanger mounting plate 20 to pipe clamps of different size.

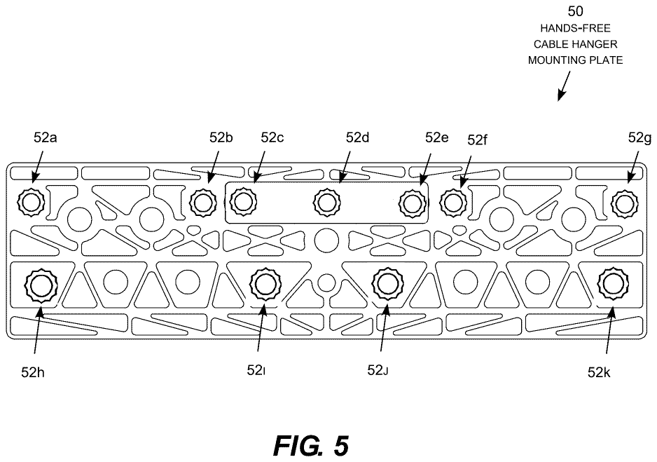

FIG. 5 is a front view of another representative cable hanger supporting plate 50 including a larger number of nut positioners 52a-52k. In this example, the nut positioners 52a-52g are smaller than the nut positioners 52h-52k for accommodating bracket nuts for threaded rods having different diameters. Other selections of nut positioner sizes and positions may be provided as a matter of design choice.

It will be further appreciated that hands-free cable hanger mounting plates may be incorporated into any of the stand-off clamp variations described with reference to the following figures to improve upon the embodiments described in U.S. Pat. No. 11,187,351.

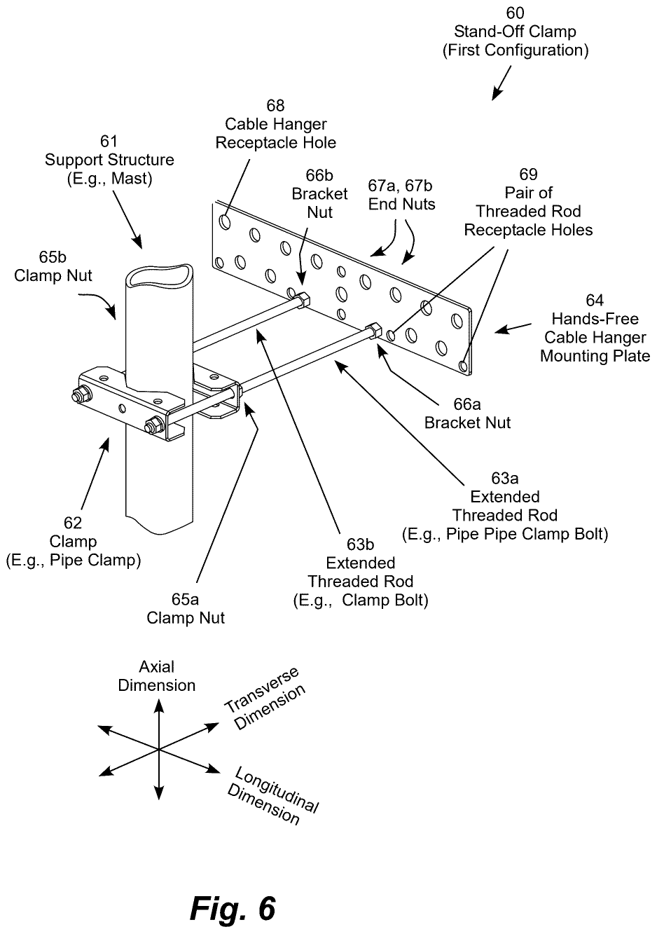

For example, FIG. 6 shows a representative stand-off clamp 60 in a first configuration. FIG. 6 also depicts orthogonal axial, transverse, and longitudinal spatial dimensions for descriptive reference. The stand-off clamp cable mounting system 60 includes a clamp 62 (e.g., pipe clamp) attached to a support structure 61, such as an upright mast (e.g., vertical pipe). The clamp 62, which is fabricated from a pair of clamp brackets, threaded rods 63a, 63b (e.g., clamp bolts or threaded rods without heads) and attachment hardware (e.g., nuts, washers, lock washers), allows the stand-off clamp 60 to be attached to the support structure 61 at a range of positions in the axial dimension. The stand-off clamp 62 includes a pair of extended threaded rods 63a, 63b, such as clamp bolts, that secure the clamp to the support structure 61 while extending away from the clamp to also support a hands-free cable hanger mounting plate 64 positioned away from the clamp along the threaded rods. In this example, the support structure 61 is elongated in the axial dimension, the threaded rods 63a, 63b are elongated in the transvers dimension and spaced apart in the longitudinal dimension, and the hands-free cable hanger mounting plate 64 is elongated in the longitudinal dimension. Clamp nuts 65a, 65b (only clamp nut 65a is visible in FIG. 6) are threaded onto the extended threaded rods 63a and 63b, respectively, to secure the clamp 62 to the support structure 61.

The bracket nuts 66a and 66b threaded onto the threaded rods 63a and 63b, respectively, position the hands-free cable hanger mounting plate 64 a “stand-off distance” away from the support structure in the transverse dimension. End nuts 67a, 67b (labeled but not shown in FIG. 6) threaded onto the extended threaded rods 63a and 63b, respectively, are tightened against the bracket nuts 66a and 66b, respectively, with the hands-free cable hanger mounting plate 64 positioned between the bracket nuts and the end nuts (typically with suitable washers and lock washers) to secure the hands-free cable hanger mounting plate at the desired stand-off distance from the clamp 62. The clamp nuts, bracket nuts, and end nuts are typically interchangeable standard sized nuts used to assemble the clamps and cable mounts with standard sized washers and lock washers to minimize the number of different parts in the attachment hardware inventory.

The lengths of the threaded rods 63a and 63b and positions of the bracket nuts 66a and 66b can be adjusted to position the hands-free cable hanger mounting plate 64 at a range of stand-off distances from the support structure 61 in the transverse dimension. The hands-free cable hanger mounting plate 64 includes a number of cable hanger receptacle holes, represented by the enumerated cable hanger receptacle hole 68, allowing a variety of cable hangers to be connected to the hands-free cable hanger mounting plate at a variety of locations on the hands-free cable hanger mounting plate. The hands-free cable hanger mounting plate 64 also includes a number of pairs of threaded rod receptacle holes, represented by the enumerated threaded rod receptacle holes 69, allowing the mounting plate to be connected to the threaded rods 63a and 63b at a variety of positions in the longitudinal dimension. More specifically, the hands-free cable hanger mounting plate 64 includes multiple pairs of the threaded rod receptacle holes, with each pair corresponding to the nominal longitudinal of the spacing of the threaded rods 63a and 63b. This allows the hands-free cable hanger mounting plate to be attached to the threaded rods at a variety of positions in the longitudinal dimension, providing flexibility in the longitudinal alignment between the hands-free cable hanger mounting plate 64 and the clamp 62. The threaded rod receptacle holes 69 also allow the threaded rods 63a and 63b to pass through the hands-free cable hanger mounting plate 64. This allows the hands-free cable hanger mounting plate 64 to be attached to the threaded rods 63a and 63b at a range of stand-off distances from the support structure 61 in the transverse dimension. These features allow the stand-off clamp cable mounting system 60 to be easily adapted to provide a wide range of cable support and positioning configurations to meet a wide range of multiple-cable routing requirements including those involving tight and looped cable routing configurations.

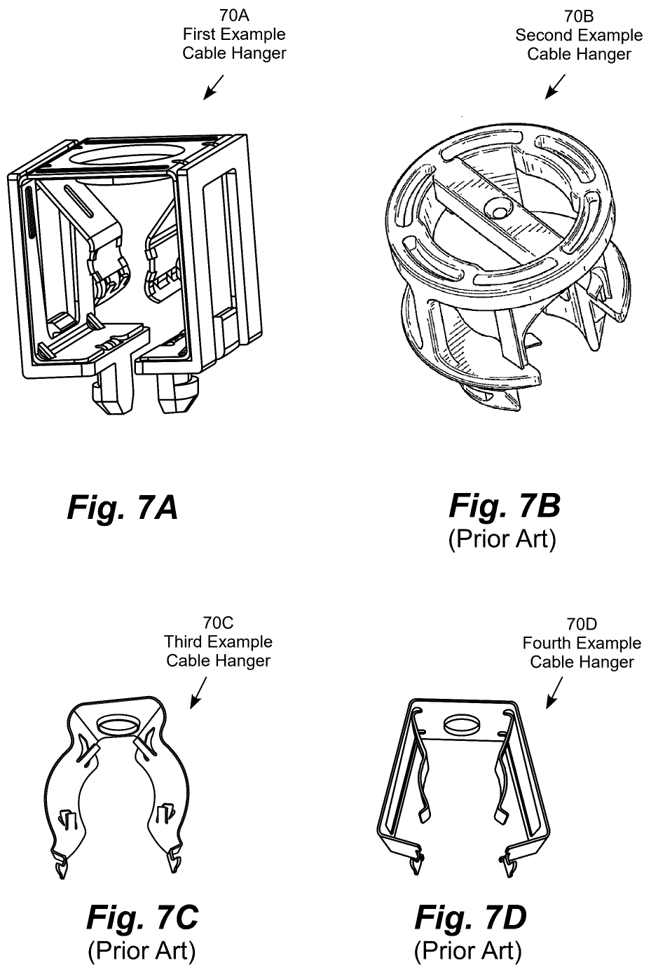

The cable hanger receptacle holes are sized to receive the feet of a variety of commercially available cable hangers. In general, the cable hanger receptacle holes may be nominal ¾ inch round holes, which have been adopted as a standard size for a variety of commercially available cable hangers. FIGS. 7A-7D depict four commercially available cable hangers that can be used with the stand-off clamp cable mounting system with standard ¾ inch round cable hanger receptacle holes. FIG. 7A shows a low-PIM cable hanger 70A that includes a polymeric jacket attached to a metal hanger body as described in Bell et al., U.S. Pat. No. 10,637,229. FIG. 7B shows an all plastic cable hanger 70B as described in Vacarro, U.S. Pat. No. 10,253,906. Since the cable hangers 70A and 70B include polymeric feet and mounting surfaces, they can be used to create low-PIM connections with stand-off clamp cable mounting systems that include metallic hands-free cable hanger mounting plates. FIGS. 7C and 7D show conventional metal cable hangers 70C and 70D, respectively, that have metallic feet sized to fit into standard ¾ inch cable hanger receptacle holes. Since the cable hangers 70C and 70D include metallic feet and mounting surfaces, they can be used to create low-PIM connections with stand-off clamp cable mounting systems that include hands-free cable hanger mounting plates fabricated from or coated with a polymeric material.

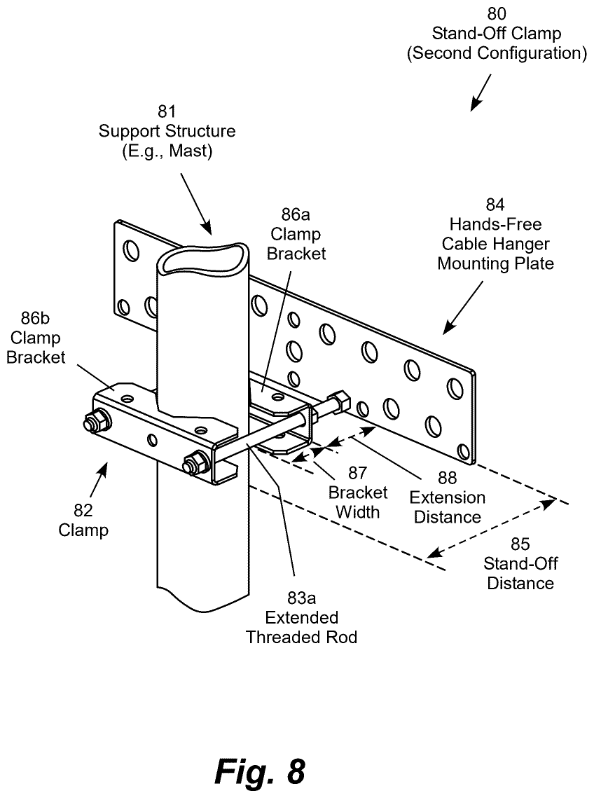

FIGS. 8-12 illustrate the flexibility of the stand-off clamp cable mounting system utilizing a minimal number of parts. For example, FIG. 8 illustrates a stand-off clamp 80 in a second configuration in which the stand-off distance between the hands-free cable hanger mounting plate 84 and the support structure 81 is less than the stand-off distance between the hands-free cable hanger mounting plate 64 and the support structure 61 of the assembly shown in FIG. 6. The support structure 81 is a mast, in this example a round pipe, that is elongated along the axial dimension. The mast is typically, but not necessarily, vertically oriented. The hands-free cable hanger mounting plate 84 is elongated in the longitudinal dimension and positioned a stand-off distance 85 from the support structure 81 in the transverse dimension. More specifically, the threaded rods, represented by the enumerated threaded rod 83a, support the hands-free cable hanger mounting plate 84 the stand-off distance 85 from the support structure 81 in the transverse dimension. The clamp 82 includes two clamp brackets 86a and 86b that are tightened onto the support structure 81 by suitable attachment hardware (e.g., nuts, washers) carried on the threaded rods. The clamp bracket 86a nearest to the hands-free cable hanger mounting plate 84 in the transverse dimension has a bracket width 87 in the transverse dimension. The hands-free cable hanger mounting plate 84 is supported an extension distance 88 from the clamp bracket 86a in the transverse dimension. In this particular embodiment, the extension distance 88 is greater than the bracket width 87 in the transverse dimension.

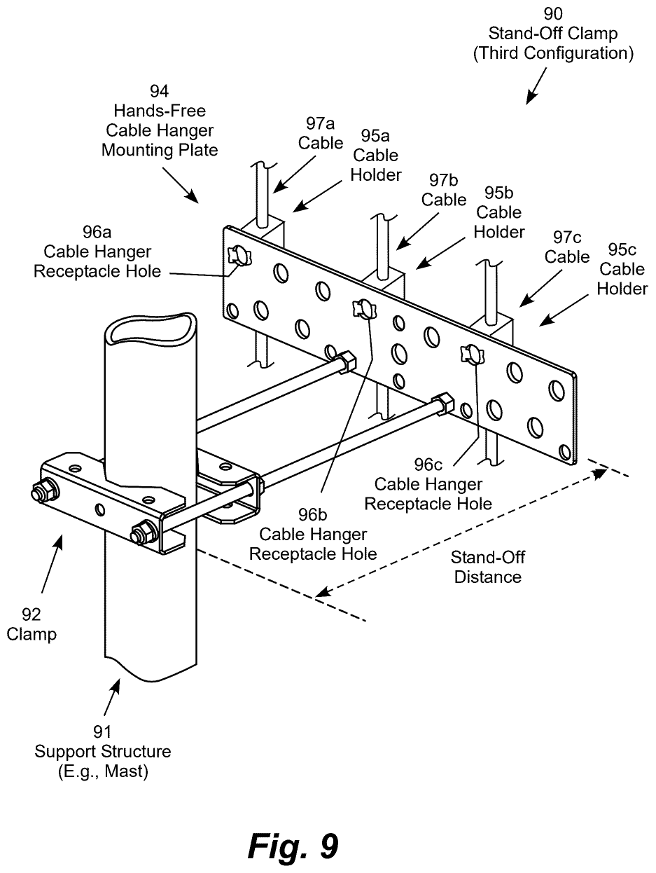

Similarly, FIG. 9 illustrates a stand-off clamp 90 in a third configuration in which the stand-off distance between the hands-free cable hanger mounting plate 94 and the support structure 91 is greater than the stand-off distance between the hands-free cable hanger mounting plate 64 and the support structure 61 of the assembly shown in FIG. 6. In general, a technician can replace the threaded rods with threaded rods of a desired length to allow the hands-free cable hanger mounting plate to be positioned a desired stand-off distance from the support structure 91. FIG. 9 also depicts three representative cable holders 95a-95c received in respective cable hanger receptacle holes 96a-96c of the hands-free cable hanger mounting plate 94. Each cable holder 95a-95c supports a respective cable 97a-97c. Although single-cable cable holders are illustrated, a variety of multi-cable holders and support brackets may also be supported by the hands-free cable hanger mounting plate 94.

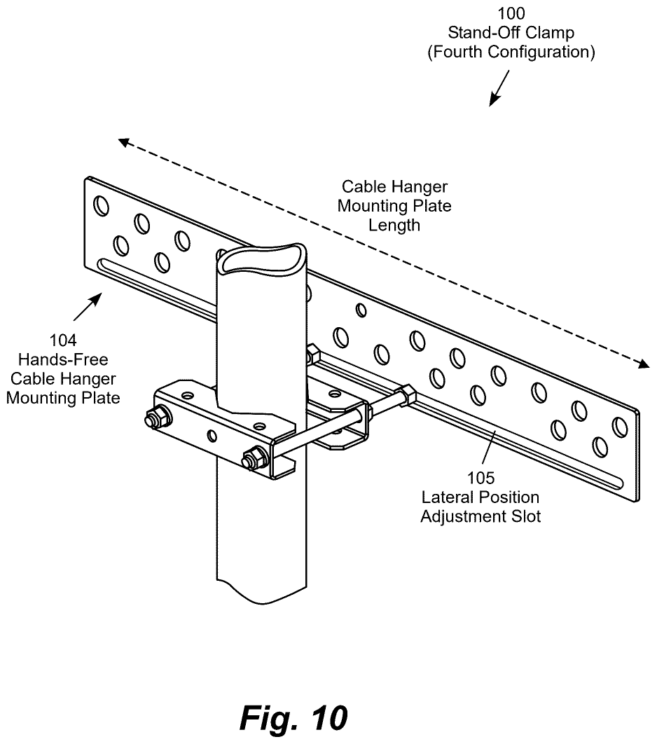

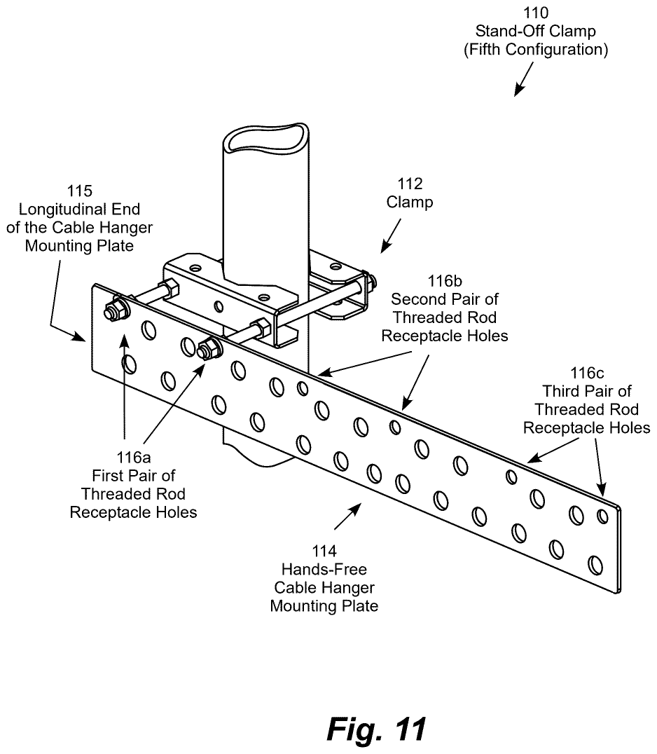

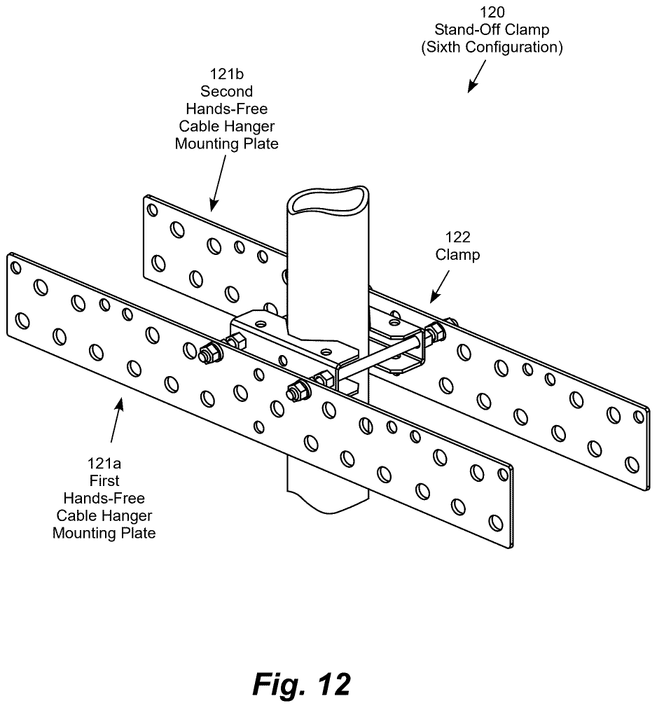

To illustrate another configuration flexibility feature of the system, FIG. 10 illustrates a stand-off clamp 100 in a fourth configuration in which the hands-free cable hanger mounting plate 104 is longer in the longitudinal direction than the mounting plate 64 the assembly shown in FIG. 6. FIG. 10 also illustrates a lateral position adjustment slot 105, which is an alternate feature for configuring the hands-free cable hanger mounting plate 104 with position adjustment flexibility in the longitudinal dimension. FIG. 11 illustrates another configuration flexibility feature of the system. This example includes a stand-off clamp 110 in a fifth configuration in which the hands-free cable hanger mounting plate 114 is mounted to the clamp 112 toward one longitudinal end 115 of the hands-free cable hanger mounting plate 114. The hands-free cable hanger mounting plate 114 includes a repeating hole pattern that allows the hands-free cable hanger mounting plate 114 to be attached to the clamp 112 with a number of different alignments in the longitudinal dimension between the hands-free cable hanger mounting plate and the clamp. In this example, the repeating hole pattern is represented by the enumerated locations including a first pair of threaded rod receptacle holes 116a, a second pair of threaded rod receptacle holes 116b, and a third pair of threaded rod receptacle holes 116c. FIG. 12 illustrates a stand-off clamp 120 in a sixth configuration, in which two hands-free cable hanger mounting plates 121a and 121b are attached to the same pair of threaded rods on opposing sides of a common clamp 122. The configuration flexibility features illustrated by FIG. 8-12 can be combined and tailored to create a wide range of cable routing configurations with a minimal number of parts, which allows a technician to assemble a wide range of cable mounting configurations by selecting among a few standard lengths of the mounting plates and threaded rods, along with common assembly hardware, from a small number of components carried on a technician's utility truck.

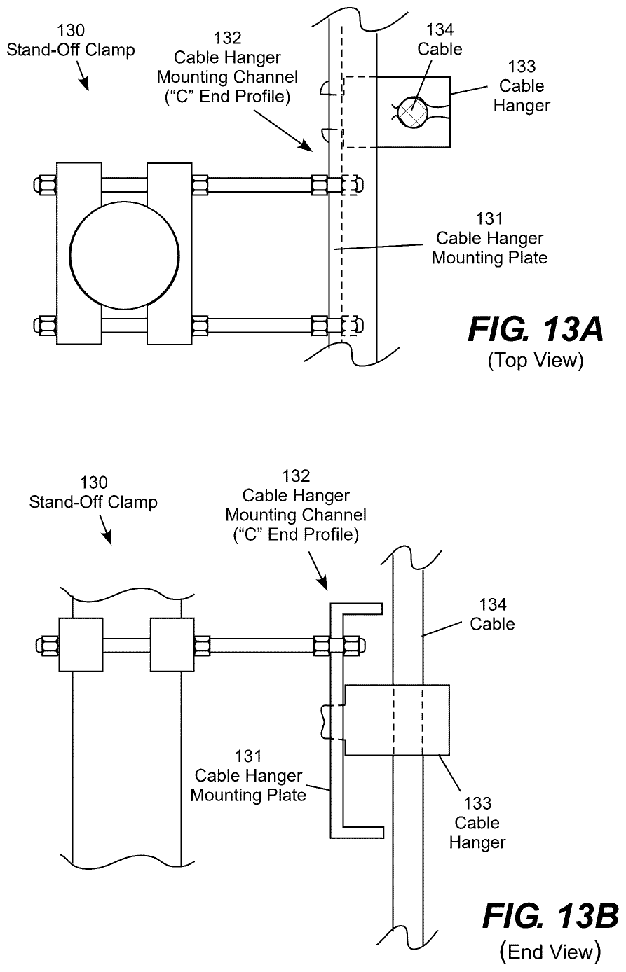

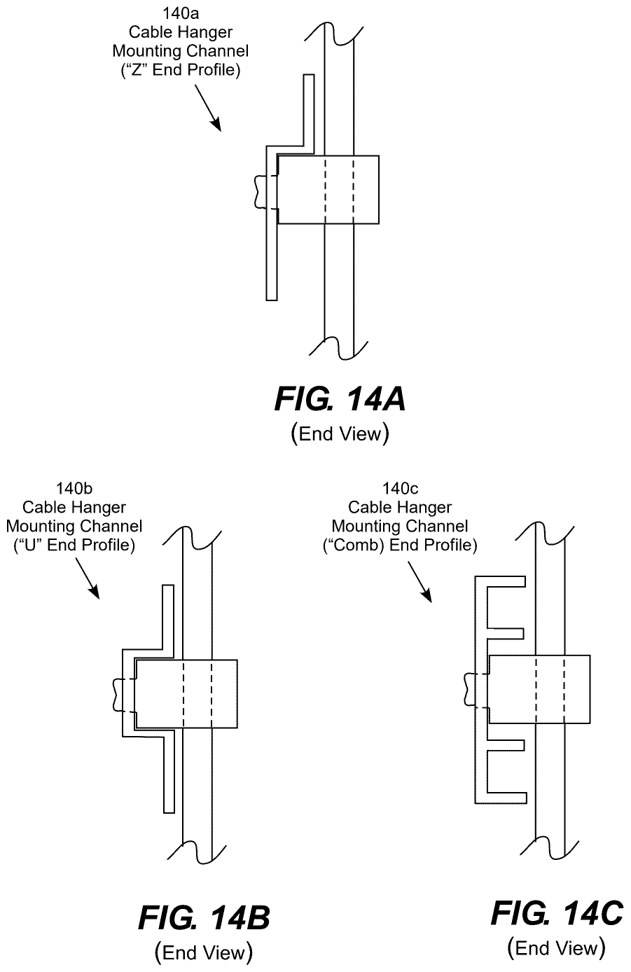

FIGS. 13A and 13B illustrate a technique for adding stiffness to the hands-free cable hanger mounting plates. FIG. 13A is a top view and FIG. 13B is an end view of a stand-off clamp 130 including a hands-free cable hanger mounting plate 131 that is formed as part of a channel 132. The hands-free cable hanger mounting plate 131 supports a number of cable hangers represented by the depicted cable hanger 133. Each cable hanger supports one or more cables represented by the depicted cable 134. The cable hanger mounting channel 132 has a “C” shaped end profile to add strength and resist bending and twisting. This type of strengthening feature can be added during the extruding process for metal mounting plates and incorporated into the molds for polymeric mounting plates. To achieve additional stiffness, ribs may be added in the length or width directions. For the polymeric versions (as well as extruded aluminum metallic version) these ribs may be incorporated in the extruded profile. For the steel versions, the strengthening features may be accomplished by adding bends to a sheet metal blank. A polymeric coating may be applied after the sheet metal blank has been formed into the desired shape. For additional examples, FIG. 14A is an end view of a cable hanger mounting channel 140a with a “Z” shaped end profile, FIG. 14B is an end view of a cable hanger mounting channel 140b with a “U” shaped end profile, and FIG. 14C is an end view of a cable hanger mounting channel 140c with a “comb” shaped end profile. Cable hanger mounting channels with other shapes may also be used, such as square or rectangular profiles, and so forth.

For the embodiments including cable hanger mounting channels, the width of the channel is generally determined by the cable hanger the channel is designed to support and should prevent the cable hanger mounting channel from pressing directly against the cable. In order to be able to compress the snap-in attachment feet of the cable hanger towards each other, there should be a clearance distance that spaces the cable away from the channel. Geometric features of the channel that are less than this clearance distance add stiffness without interfering with the cables. Given that stiffness of a channel increases with the cube of channel width dimension, small increases in channel width will produce a very large increase in stiffness. The stiffening feature become increasingly important as the channel becomes longer or produced from weaker materials, such as thinner sheet metal or materials with lower modulus of elasticity compared to steel such as aluminum, extruded plastic, etc.

A metallic hands-free cable hanger mounting plate may be made of galvanized steel, stainless steel, electroplated steel or another suitable material. A polymeric hands-free cable hanger mounting plate may be made of may be fabricated, for example, from injection molded, glass filled nylon, ASB (acrylonitrile butadiene styrene), Acetal or POM (polyoxymethylen), PC (polycarbonate), PVC (polyvinyl chloride), and the like. Alternatively, a metal mounting plate body may be coated with a suitable polymeric material, such as PVC, natural or synthetic rubber, urethane, acrylic, epoxy, or the like. The cable mounting plates are also amenable to other suitable fabrication processes, such as compression molding, 3D printing, and so forth.

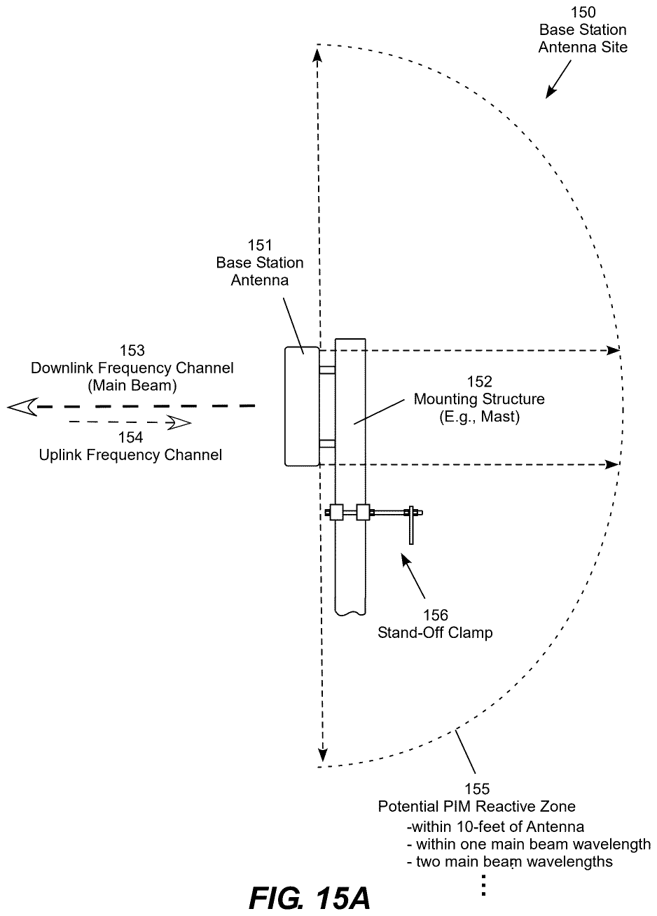

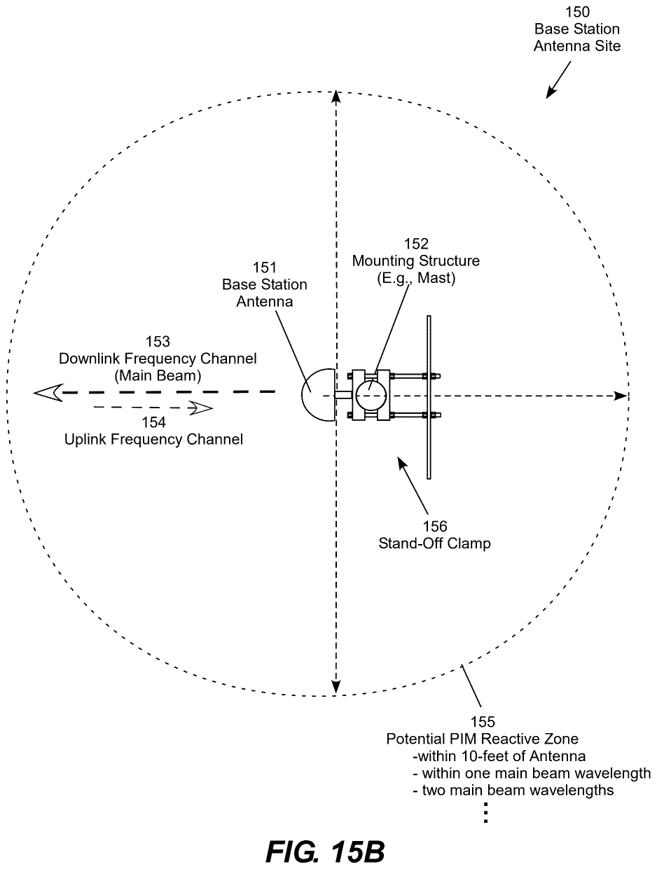

FIG. 15A is a conceptual side view and FIG. 15B is a conceptual top view of a representative base station antenna site 150 that includes a base station antenna 151 supported by a support structure 152, such as a vertical mast (e.g., metal pipe). To briefly recap the problem to be solved, the antenna 151 directionally broadcasts higher-power downlink communication signals away from the antenna (generally referred to as the “main beam” of the antenna) within a downlink frequency channel 153 to registered mobile communication devices within the communication reach of the antenna. The antenna 151 also receives lower-power uplink communication signals from the registered mobile communication devices within a separate uplink frequency channel 154 allowing for duplex communications, such as mobile telephone conversations, between the antenna 151 and the registered mobile communication devices within the communication reach of the antenna. Passive intermodulation (“PIM”) interference occurs when the downlink signals within the downlink frequency channel 153 mix at nonlinear junctions near the antenna 151 to create noise within the uplink frequency channel 154 received by the antenna. The PIM interference decreases the signal-to-interference plus-noise ratio (“SINR”) of the uplink channel of the antenna 151, which reduces the communication quality and information carrying capacity (bandwidth) of the uplink frequency channel.

It is well documented that loosely touching metal-to-metal surfaces can behave in a non-linear fashion and become sources of PIM interference when illuminated by high power RF signals. For this reasons, the coaxial cables and other components associated with operation of the antenna are located well outside and behind the main beam of the antenna. It has recently been determined, however, that loose metal-to-metal connections located behind a base station antenna can generate high levels of passive intermodulation. Even though this region is well outside the main beam of the antenna, enough RF energy can be present in this region to excite non-linear objects and generate PIM interference. Metal brackets and associated hardware for supporting RF, optical, ground and remote electrical tilt (“RET”) cables are common sources of loose metal-to-metal contact found in this region behind and close to the base station antenna. Embodiments of the present invention include a range of low-PIM stand-off clamps designed to mitigate PIM interference by the equipment used to support the cables and other components associated with the operation of the antenna, which are typically located near the antenna outside the main beam of the antenna.

To develop standards for mitigating PIM, technicians may define a potential PIM reactive zone 155 in which PIM mitigation equipment should be installed. FIGS. 15A-15B illustrate this practice for a representative example base station antenna site 150, in which a representative low-PIM stand-off clamp 156 is attached to the support structure 152 within a potential PIM reactive zone 155 defined for an antenna 151. In this example, the representative low-PIM cable hanger assembly 156 is located well outside the main beam 153 and physically behind the antenna 151 on the opposite side of the support structure 152 from the antenna. The low-PIM stand-off clamp 156 is nevertheless specified to provide PIM mitigation because it is still located with the potential PIM reactive zone 155 defined for the antenna 151. The low-PIM stand-off clamp 156 is representative of the low-PIM cable hanger assemblies generally, as all of the low-PIM cable hanger assemblies described in the disclosure, and variations of these specific examples, are intended for deployment as PIM mitigation measures in the potential PIM reactive zones of cellular base station antennas.

While the low-PIM stand-off clamp cable mounting system assembly embodiments of the present invention can be utilized in any desired location, they are particularly effective for mitigating PIM interference when deployed in the potential PIM reactive zone 155 near the base station antenna 151. Although PIM generation is a function of the antenna broadcast frequency and power, technicians may use a standard distance, such as 10-feet from the antenna 151, to establish the potential PIM reactive zone 155 where PIM mitigation is appropriate. As other options, the potential PIM reactive zone 155 may be established to be a function of the antenna broadcast frequency, such as one or two wavelengths of the main beam frequency channel 153 of the antenna 151. Other factors, such as the broadcast power of the antenna 151, the presence of reflective surfaces in the physical environment of the antenna, the width of the uplink channel, the use of electronic filtering, and other relevant factors may also be taken into account when establishing the potential PIM reactive zone for a particular antenna. For administrative simplicity, however, the standard set for potential PIM reactive zone 155 may ultimately be defined to be a set distance, such as 10-feet from the antenna.

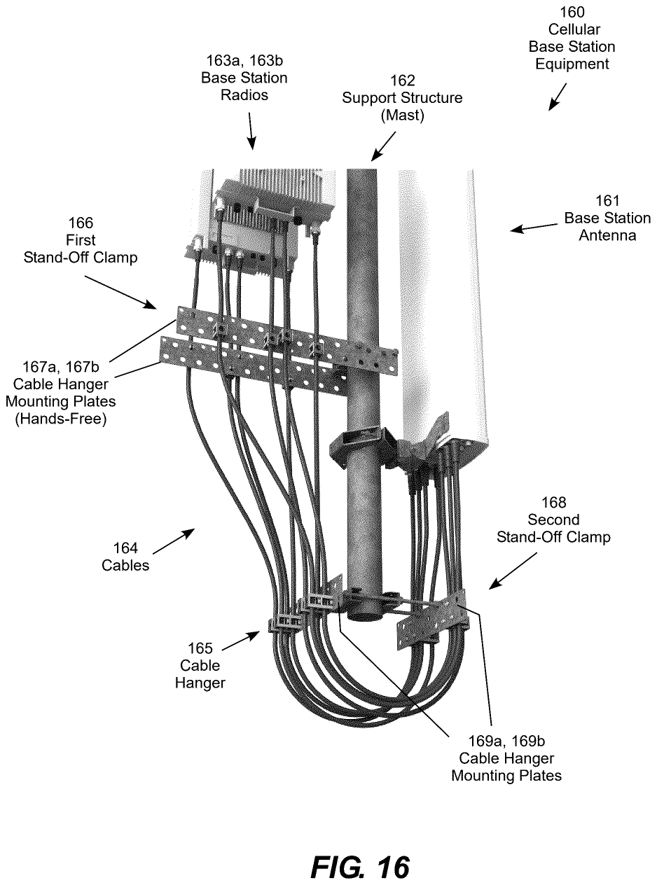

FIG. 16 is a perspective view of cellular base station equipment 160 including a base station antenna 161 attached to a support structure 162, which in this example is a vertical mast. A pair of base station radios 163a, 163b are attached to the same support structure 162 within a few feet from the base station antenna 161. In this embodiment, 8 cables 164 are connected between the base station radios 163 the base station antenna 161. The cables are looped in a tight cable routing configuration as a result of the close spacing between the base station radios and the antenna attached to the common support structure. A number of cable hangers represented by the enumerated cable hanger 165 are used to organize and secure the cables 164. The cable hangers 165 are positioned and supported by a pair of standoff clamp cable mounting systems 166 and 168.

A first standoff clamp cable mounting assembly 166 secures the cables 164 near the base station radios 163a and 163b, typically within 18 inches from the radios. The first standoff clamp cable mounting assembly 166 utilizes two hands-free cable hanger mounting plates 167a and 167b attached to the common support structure 162, which also supports the base station radios 163a and 163b and the base station antenna 161. Each hands-free cable hanger mounting plate secures the cables coming from a respective radio to the support structure. The hands-free cable hanger mounting plates 167a, 167b are mounted on opposing sides of the support structure 162 to facilitate routing the cables from the radios 163a, 163b, which are also secured to opposing sides of the support structure. To reach the desired cable support positions directly below the radios 163a and 163b, the hands-free cable hanger mounting plates 167a and 167b each have an offset longitudinal alignment with the support structure 162. More specifically, the hands-free cable hanger mounting plate 167a and 167b are each mounted adjacent to a longitudinal end of the hands-free cable hanger mounting plate as described previously with reference to FIG. 11. This configuration combines the longitudinal offset configuration feature shown in FIG. 11 with the dual mounting plate configuration feature shown in FIG. 12.

A second standoff clamp cable mounting assembly 168 secures the cables 164 near the bottom of the base station antenna 161, typically within 18 inches from the antenna. The second standoff clamp cable mounting system 168 also utilizes two hands-free cable hanger mounting plates 169a and 169b attached to the common support structure 162. Each of the hands-free cable hanger mounting plates 169a and 169b secures the cables coming from both radios 163a and 163b to the support structure 162 in a tightly looped configuration routing the cables from the radios to the antenna. The hands-free cable hanger mounting plates 169a and 169b are mounted on opposing sides of the support structure 162 to facilitate the looped cable routing configuration. This configuration utilizes the dual mounting plate configuration feature shown in FIG. 12 to implement the looped cable routing configuration from the radios 163a and 163b to the antenna 161. While FIG. 16 illustrates one representative cable routing configuration that can be implemented with the standoff clamp cable mounting system, it will be readily apparent that the system can be assembled to organize and secure cables in a wide variety of configurations.

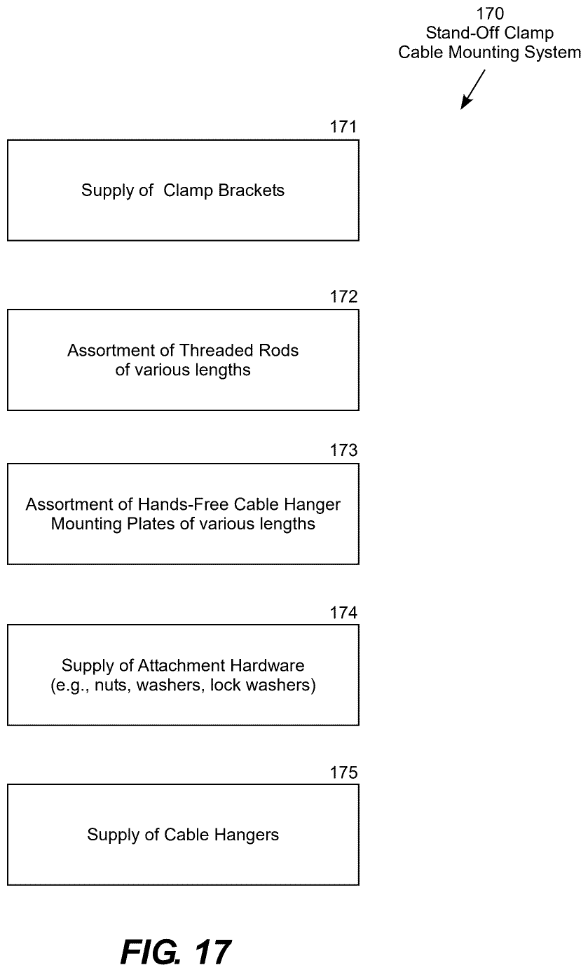

FIG. 17 is a block diagram 170 illustrating the minimal number of parts of the highly configurable stand-off clamp cable mounting system described above. All of the assembly configurations illustrated in these figures can be assembled from the minimal number of parts shown in FIG. 17, which includes a supply of clamp brackets 171, an assortment of threaded rods of various lengths 172, an assortment of hands-free cable hanger mounting plates of various lengths 173, a supply of attachment hardware (e.g., nuts, washers, lock washers) 174, and a supply of cable hangers 175.

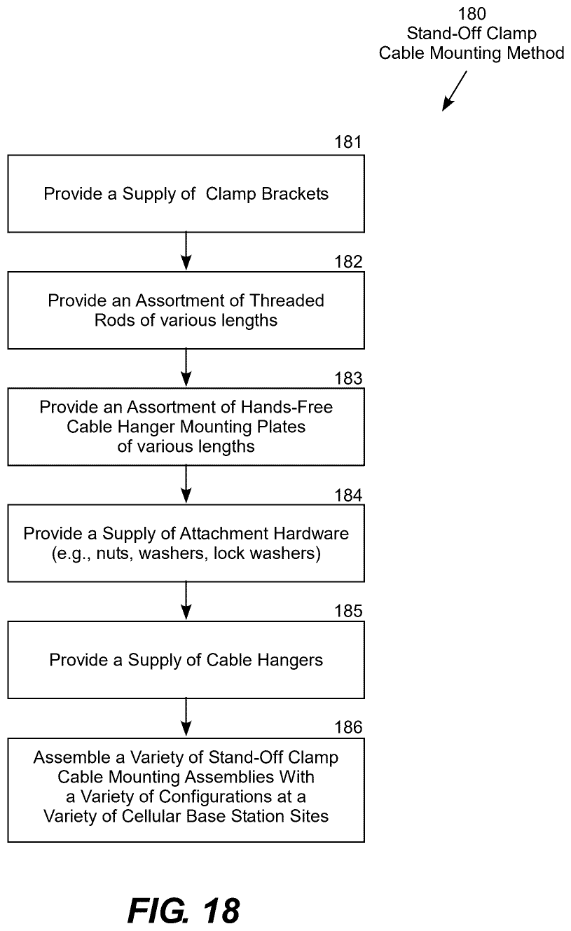

FIG. 18 is a block diagram illustrating a method 180 for a stand-off clamp cable mounting system. In steps 181-185, the operator of the method provides a minimal number of parts including a supply of clamp brackets, an assortment of threaded rods of various lengths, an assortment of hands-free cable hanger mounting plates of various lengths, a supply of attachment hardware (e.g., nuts, washers, lock washers), and a supply of cable hangers. The minimal number of parts is typically stored on a technician's utility truck for use at a variety of cellular base station sites. Steps 181-185 are followed by step 185, in which the technician assembles a variety of stand-off clamps with a variety of configurations from the minimal number of parts at a variety of cellular base station sites. It will therefore be appreciated that the stand-off clamp cable mounting system provides an extraordinary range of configuration flexibility with a minimal number of parts that can be easily carried on a technician's utility truck.

Although particular aspects of the present subject matter have been shown and described in detail, it will be apparent to those skilled in the art that, based upon the teachings of this disclosure, changes and modifications may be made without departing from the subject matter described in this disclosure and its broader aspects and, therefore, the appended claims are to encompass within their scope all such changes and modifications as are within the true spirit and scope of the subject matter described in this disclosure. Although particular embodiments of this disclosure have been illustrated, it is apparent that various modifications and embodiments of the disclosure may be made by those skilled in the art without departing from the scope and spirit of the disclosure.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. The disclosure is defined by the following claims, which should be construed to encompass one or more structures or function of one or more of the illustrative embodiments described above, equivalents and obvious variations. It will therefore be appreciated that the present invention provides significant improvements. The foregoing relates only to the exemplary embodiments of the present invention, and that numerous changes may be made therein without departing from the spirit and scope of the invention as defined by the following claims.

The invention claimed is:

1. A stand-off clamp, comprising:
a pipe clamp comprising a pair of threaded rods;
a hands-free cable hanger mounting plate comprising a pair of nut positioners configured to support the hands-free cable hanger mounting plate on bracket nuts carried on the threaded rods without the use of hands while end nuts are installed on the threaded rods to secure the hands-free cable hanger mounting plate between the bracket nuts and the end nuts.

2. The stand-off clamp of claim 1, wherein:
the pipe clamp further comprises clamp brackets for attaching to a support structure extending in an axial dimension, and the threaded rods are elongated in a transverse dimension orthogonal to the axial dimension;
the clamp nut releasably engage with respective threaded rods;
the clamp nuts configure the clamp for adjustable initial positioning and future repositioning in the axial dimension;
the hands-free cable hanger mounting plate elongated in a longitudinal dimension orthogonal to the axial and transverse dimensions positioned with the threaded rods extending through the hands-free cable hanger mounting plate;
the pair of bracket nuts, each bracket nut releasably engaged with a respective threaded rod of the pair of threaded rods, wherein the bracket nuts configure the hands-free cable hanger mounting plate for adjustable initial positioning and future repositioning in the transverse dimension;
the pair of end nuts, each end nut releasably engaged with a respective threaded rod of the pair of threaded rods, wherein the end nuts are configured for tightening the hands-free cable hanger mounting plate against the bracket nuts with the cable hanger mount plate positioned at a selected standoff distance from the support structure in the transverse dimension;
the hands-free cable hanger mounting plate further comprising a plurality cable hanger receptacle holes;
the hands-free cable hanger mounting plate further comprises a pair of nut positioners configured to support the hands-free cable hanger mounting plate on the bracket nuts without the use of hands while the end nuts are installed on the threaded rods to secure the hands-free cable hanger mounting plate between the bracket nuts and the end nuts.

3. The stand-off clamp of claim 2, wherein the hands-free cable hanger mounting plate further comprises a plurality of pairs of threaded rod receptacle holes configuring the hands-free cable hanger mounting plate for adjustable initial positioning and future repositioning in the longitudinal dimension.

4. The stand-off clamp of claim 2, wherein the hands-free cable hanger mounting plate further comprises a lateral slot configuring the hands-free cable hanger mounting plate for adjustable initial positioning and future repositioning in the longitudinal dimension.

5. The stand-off clamp of claim 2, wherein each cable hanger receptacle hole is adapted to removably receive a snap-in cable hanger removably supporting an antenna communication or control cable, further comprising a plurality of snap-in cable hangers, each of the snap-in cable hangers removably received within a respective cable hanger receptacle hole of the plurality of cable hanger receptacle holes.

6. The stand-off clamp of claim 5, further comprising a plurality of cables, each cable extending through a respective cable hanger of the plurality of cable hangers.

7. The stand-off clamp of claim 6, wherein the hands-free cable hanger mounting plate is fabricated from a metallic material and each cable hanger comprises polymeric feet configuring each cable hanger for low-PIM attachment to the hands-free cable hanger mounting plate.

8. The stand-off clamp of claim 6, wherein each cable hanger comprises metallic feet and the hands-free cable hanger mounting plate is fabricated from or coated with a polymeric material configuring each cable hanger for low-PIM attachment to the hands-free cable hanger mounting plate.

9. The stand-off clamp of claim 2, wherein a channel comprises the hands-free cable hanger mounting plate.

10. The stand-off clamp of claim 9, wherein the channel comprises an end profile with a “C” shape, a “Z” shape, a “U” shape or a “comb” shape.

11. A method for supporting one or more cables, comprising:
attaching a pipe clamp comprising a pair of threaded rods to a support structure;
threading a pair of bracket nuts onto respective threaded rods a stand-off distance from the support structure;
attaching a cable hanger mounting plate comprising a pair of nut positioners by pressing the nut positioners onto respective bracket nuts for hands-free support the cable hanger mounting plate from bracket nuts;
tightening a pair of end nuts on respective threaded rods to secure the cable hanger mounting plate between the bracket nuts and the end nuts while the cable hanger mounting plate is supported by the nut positioners without the use of hands;
attaching one or more cable hangers to the cable hanger mounting plate;
attaching the cable hangers to one or more cables to secure the cables to the cable hanger mounting plate.

12. A method for assembling stand-off clamps having a variety configurations, comprising:
providing a supply of clamp brackets;
providing an assortment of threaded rods of various lengths;
providing an assortment of hands-free cable hanger mounting plates of various lengths;
providing a supply of attachment hardware including nuts interchangeably usable as clamp nuts, bracket nuts, and end nuts;
providing a supply of cable hangers;
assembling the clamp brackets, threaded rods, hands-free cable hanger mounting plates, and cable hangers to fabricate a plurality of stand-off clamps having a variety configurations, wherein each stand-off cable mounting assembly comprises:
a clamp comprising a pair of threaded rods attaching the clamp to a support structure extending in an axial dimension, wherein the threaded rods are elongated in a transverse dimension orthogonal to the axial dimension;
a pair of clamp nuts, each clamp nut releasably engaged with a respective threaded rod of the pair of threaded rods, wherein the clamp nuts configure the clamp for adjustable initial positioning and future repositioning in the axial dimension;
a hands-free cable hanger mounting plate elongated in a longitudinal dimension orthogonal to the axial and transverse dimensions positioned with the threaded rods extending through the hands-free cable hanger mounting plate;
a pair of bracket nuts, each bracket nut releasably engaged with a respective threaded rod of the pair of threaded rods, wherein the bracket nuts configure the hands-free cable hanger mounting plate for adjustable initial positioning and future repositioning in the transverse dimension;
a pair of end nuts, each end nut releasably engaged with a respective threaded rod of the pair of threaded rods, wherein the end nuts are configured for tightening the hands-free cable hanger mounting plate against the bracket nuts with the cable hanger mount plate positioned at a selected standoff distance from the support structure in the transverse dimension;
the hands-free cable hanger mounting plate further comprising a plurality cable hanger receptacle holes, wherein each cable hanger receptacle hole is adapted to removably receive a snap-in cable hanger removably supporting an antenna communication or control cable;
wherein the hands-free cable hanger mounting plate further comprises a pair of nut positioners configured to support the hands-free cable hanger mounting plate on the bracket nuts without the use of hands while the end nuts are installed on the threaded rods to secure the hands-free cable hanger mounting plate between the bracket nuts and the end nuts.

13. The method of claim 12, further comprising providing each hands-free cable hanger mounting plate with a plurality of pairs of threaded rod receptacle holes configuring each hands-free cable hanger mounting plate for adjustable initial positioning and future repositioning in the longitudinal dimension.

14. The method of claim 12, further comprising providing each hands-free cable hanger mounting plate with a lateral slot configuring the hands-free cable hanger mounting plate for adjustable initial positioning and future repositioning in the longitudinal dimension.

15. The method of claim 12, wherein each cable hanger receptacle hole is adapted to removably receive a snap-in cable hanger removably supporting an antenna communication or control cable, further comprising removably receiving each of the snap-in cable hangers within a respective cable hanger receptacle hole of the plurality of cable hanger receptacle holes.

16. The method of claim 15, further comprising providing a plurality of cables, and receiving each cable through a respective cable hanger of the plurality of cable hangers.

17. The method of claim 16, further comprising providing a plurality of the hands-free cable hanger mounting plates fabricated from a metallic material, and providing a plurality of the cable hangers comprising polymeric feet for low-PIM attachment to the hands-free cable hanger mounting plates.

18. The method of claim 17, further comprising providing a plurality of the cable hangers comprising metallic feet, and providing a plurality of the hands-free cable hanger mounting plates fabricated from or coated with a polymeric material for low-PIM attachment to the hands-free cable hanger mounting plates.

19. The method of claim 12, further comprising providing a plurality of channels wherein each channel comprises one of the hands-free cable hanger mounting plates.

20. The method of claim 19, wherein the channel comprises an end profile with a “C” shape, a “Z” shape, a “U” shape or a “comb” shape.
